(19) United States
(12) Patent Application Publication
(10) Pub. No.: US 2012/0109371 A1
(43) Pub. Date: May 3, 2012

(54) METHODS AND SYSTEMS FOR AUTOMATIC GLUE LEVEL CONTROL

(75) Inventors: AARON MATTHEW SANDERS, FAIRPORT, NY (US); JOHN ALLEN STROSSMAN, WEBSTER, NY (US); WILLIAM MATTHEW HARNEY, RUSH, NY (US); RONALD WILLIAM BOGERT, WEBSTER, NY (US); RANDY ROBERT SPRAGUE, WEBSTER, NY (US)

(73) Assignee: XEROX CORPORATION, Norwalk, CT (US)

(21) Appl. No.: 12/913,736

(22) Filed: Oct. 27, 2010

(51) Int. Cl. G05D 9/00

(52) U.S. Cl. 700/240; 700/281

(57) ABSTRACT

The present disclosure provides systems and methods for automatically controlling hot glue level in a book-binding apparatus. The embodiments include monitoring glue level in a reservoir and measuring glue temperature in the reservoir. If the glue level is below a level threshold value and the glue temperature value is above a temperature threshold, the system dispenses a predetermined amount of meltable glue pellets into the reservoir.

### TECHNICAL FIELD

The presently disclosed embodiments relate to a post-processing apparatus in an imaging system, and more particularly to a book-binding apparatus.

### BACKGROUND

Book-binding systems, which bind loose printed sheets to folders or covers, are well known in the art. These devices generally employ adhesive for binding stacks of sheets into finished products. Typically, the system applies an adhesive to the over, which is jointed onto a sheet bundle to make a book.

A book-binding machine generally employs hot glue to bind the cover to the body of the book. Such a machine may start with glue pellets, which the machine melts to a liquid state. Liquid glue is then applied to the cover or the body of the book, or both, and those two elements are brought into contact. Typical hot-glue systems include a heated glue reservoir, maintained at a specific temperature. As the books are being bound, the glue level in the reservoir falls and must be replenished. Additional glue comes in the form of pellets, of course, which must be melted. Considerable time and energy can be required to heat the glue to the required temperature, bringing the book-binding process to a halt in the interim. The amount of lost time and energy depends on the thermal property of the glue, the size of the reservoir, and amount of glue that is added. Productivity losses, however, can be considerable.

Further, adhesive performance of the glue degrades when it remains at a high temperature for an extended period of time. Performance can further degrade when the glue level runs slow. Maintaining fresh and sufficient glue in the reservoir would improve the efficiency of the book-binding process as well as the output quality. A simple and cost-effective system for providing an optimum amount of glue to the reservoir would be highly desirable. Beneficial qualities of such a system would be close control of glue temperature within the reservoir and stability of the temperature control system.

### SUMMARY

One embodiment of the present disclosure provides a method for automatically controlling hot glue level in a book-binding apparatus. The method includes monitoring glue level in a reservoir and measuring glue temperature in the reservoir. If the glue level is below a level threshold value and the glue temperature value is above a temperature threshold, the method dispenses a predetermined amount of meltable glue pellets into the reservoir.

Another embodiment discloses a system for automatically controlling hot glue level in a book-binding apparatus. The system includes a reservoir carrying the glue, a level sensor to monitor glue level in the reservoir, and a temperature sensor to measure glue temperature in the reservoir. An automatic glue dispenser dispenses glue into the reservoir if the glue level is below a level threshold value and the glue temperature is above a temperature threshold value.

### BRIEF DESCRIPTION OF THE DRAWINGS

FIG. 1 illustrates an exemplary system for automatically controlling hot glue level in a book-binding apparatus.

FIG. 2 illustrates an exemplary embodiment of a method for automatically controlling hot glue level in the system of FIG. 1.

FIG. 3 illustrates another exemplary embodiment of a method for automatically controlling hot glue level in the system of FIG. 1.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Overview

The present disclosure describes embodiments of automatic glue dispenser control systems and methods for a hot-glue book-binding machine. Some embodiments of the disclosure utilize an electronic level and temperature sensor to monitor the hot glue reservoir. A control system then dispenses an optimum quantity of glue at a chosen time to maintain a constant level and appropriate operating temperature. Although the embodiments of the present disclosure have been described in reference to book-binding, it will be understood that the present description can be applied to any type of dispensing apparatus, such as dispensing solid-ink pellets.

### Exemplary embodiments

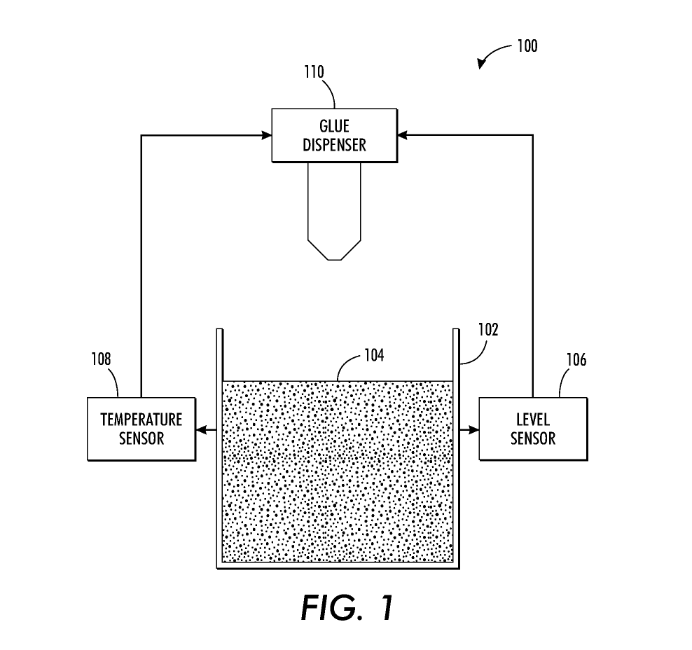

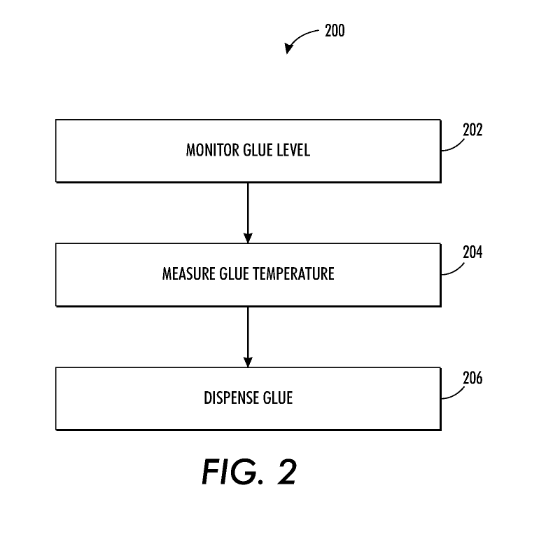

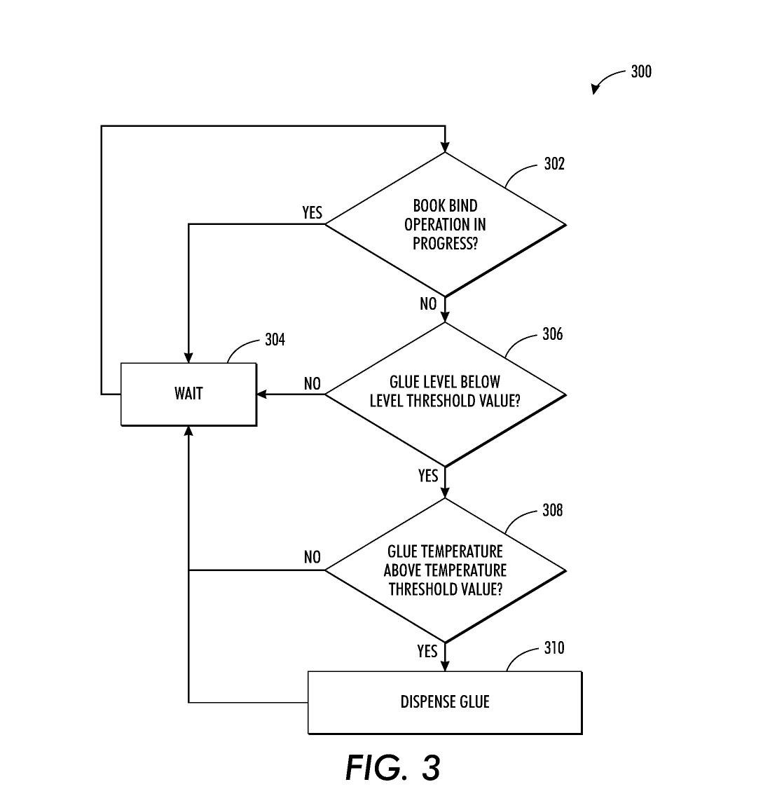

FIG. 1 illustrates an exemplary system 100 for automatically controlling hot glue level in a book-binding apparatus. The system 100 includes a reservoir 102 carrying the glue 104. A level sensor 106 monitors glue 104 level in the reservoir 102 while a temperature sensor 108 measures glue 104 temperature in the reservoir 102. The level sensor 106 can be any type of level sensor known in the art, such as mechanical, microwave, capacitance, or optical sensors. Similarly, the temperature sensor 108 may be any temperature sensor known in the art, such as contact or noncontact temperature sensors. In the present embodiment, an automatic glue dispenser 110 feeds glue 104 into the reservoir 102 if the glue 104 level is below a level threshold value, and the glue 104 temperature is above a temperature threshold value. The automatic glue dispenser 110 includes a control system (not shown) that accepts the inputs from the sensors and based on the inputs, controls the amount of glue 104 to be dispensed into the reservoir 102. In one embodiment, the control system controls the opening and closing of a valve in the automatic glue dispenser 110 for controlling the amount of glue 104 dispensed. Related methods will be described in more detail in reference to FIGS. 2 and 3.

The glue 104 may be dispensed in the form of solid glue pellets Henkel Cool-Bind adhesives. These pellets melt once deposited into the reservoir 102. The threshold values of level and temperature may be determined based on experiments and on the size of the book-binding apparatus or the reservoir 102. In the present exemplary embodiment, the level threshold value lies within a range of approximately 90% to 100% of the reservoir 102 fill level, while the temperature threshold value may lies within a range of approximately 230° F. to 250° F. Further, the threshold values may be hard coded into the system 100 or alternatively, may be provided as inputs to the system 100 by an operator through a user interface (not shown), which may be a keypad and a display, a touch screen system etc. In another embodiment of the present disclosure, the glue dispenser 110 dispenses glue 104 into the reservoir 102 on either determination that the glue 104 level is below a level threshold value or the glue 104 temperature is above a temperature threshold value.

It will be understood by those in the art that the dispenser mechanism in the system 100 is exemplary in nature and any known dispense mechanism known in the art may be employed, such as dispensing pellets from the sides or the bottom on the reservoir 102.

FIG. 2 illustrates an exemplary embodiment of a method 200 for automatically controlling hot glue 104 level in the system 100. The method 200 includes monitoring glue 104 level in the reservoir 102, at step 202. Also, the method 200 involves measuring glue temperature in the reservoir 102, at step 204. If the glue 104 level is below the level threshold value and the glue 104 temperature is above the temperature threshold value, the method 200 dispenses a predetermined amount of meltable glue 104 into the reservoir 102, at step 206. In the present exemplary embodiment, the level threshold value lies within a range of approximately 75% to 80% of the reservoir 102 fill level, while the temperature threshold value lies within a range of approximately 200° F. to 230° F. In one implementation of the present disclosure, the glue dispenser 110 dispenses glue 104 into the reservoir 102 on either determination that the glue 104 level is below a level threshold value or the glue 104 temperature is above a temperature threshold value.

As already discussed, an optimum amount of glue 104 should be dispensed into the reservoir 102. The system 100 ensures that the predetermined amount of glue 104 dispensed is sufficient to maintain the glue 104 at the required level and does not result in an undesirably low temperature. Also, the dispensed amount of glue 104 should be small enough to ensure that the dispensed glue pellets melt quickly, without affecting operation. The dispensed amount of glue 104 may be a fixed predetermined amount or alternatively, may be determined dynamically, based on book spine thickness (number of pages in the book) or different cover material.

FIG. 3 illustrates another exemplary embodiment of a method 300 for automatically controlling the system 100. First, the method 300 determines whether a book-bind operation is in progress at step 302. If an operation is in progress, the method 300 does not interrupt the operation. Rather, the system 100 waits, at step 304, for a predetermined time or until the operation is completed. If a book-bind operation is not in progress, the method 300 checks the glue 104 level in the reservoir 102. The level threshold value and the temperature threshold value may be established prior to executing the method 300.

At step 306, the method 300 determines whether the glue 104 level is below the level threshold value. If the glue 104 in the reservoir 102 is below the level threshold value, the method 300 proceeds to step 308. Alternatively, if the glue 104 level is at or above the level threshold value, the method 300 waits until the glue 104 level falls below the level threshold value, at step 304.

At step 308, the method 300 determines whether the glue 104 temperature is above the temperature threshold value. If not, the method 300 proceeds to step 304 and waits. Alternatively, if the glue 104 temperature is above the temperature threshold value, the glue dispenser 110 dispenses a predetermined amount of glue 104 at step 310 into the reservoir 102. It will be readily understood by those in the art that the steps of the described methods may be carried out in a different order, without affecting the scope of the claimed invention.

In one implementation, the system 100 may dispense glue pellets until the glue 104 in the reservoir 102 reaches the level threshold value. In another implementation, the system 100 monitors the glue 104 temperature for a small drop in temperature due to addition of the glue pellets and stops dispensing the glue pellets if the glue 104 temperature drops below a certain threshold. Once the glue 104 temperature of the glue 104 rises again and if the glue 104 level is still low, more glue pellets will be added.

In addition, based on the projected volume of book-binding operations, the glue 104 level requirement may change. For example, it may be known that only ten book-binding operations are to be performed, after which the system 100 is to be shut down for twelve hours. Accordingly, the reservoir 102 need not be filled further. Here, the level threshold value may be altered to a lower value through the user interface.

In certain implementations, the settings for the threshold values may be associated with time intervals. For example, the control system from FIG. 1 may be programmed to include predetermined operating modes. If it is known that on a typical work day, the book-binding process begins at 8 AM and ends at 6 PM, the control system can be programmed to execute the method 300 during these hours and to reduce the level threshold value to a predetermined value at 5:30 PM. Such predetermined operating modes may be programmed into the control system and may be selected by the operator. The predetermined operating modes may include various parameters such as time intervals, date values, number of book-binding operations, etc.

The various embodiments of the disclosure allow slow addition of glue 104, preventing the glue 104 temperature from dropping below an acceptable book-binding temperature. Idle time of the book-binding apparatus may be used to refill the reservoir 102.

The terminology used herein is for the purpose of describing particular embodiments only and is not intended to be limiting of the disclosure. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for automatically controlling hot glue level in a book-binding apparatus, the method comprising:
monitoring glue level in a reservoir;
measuring glue temperature in the reservoir; and
dispensing a predetermined amount of meltable glue pellets into the reservoir, upon a determination that:
the glue level is below a level threshold value; and
the glue temperature is above a temperature threshold value.

2. The method of claim 1, wherein the level threshold value lies within a range of approximately 75% to 100%.

3. The method of claim 1, wherein the temperature threshold value lies within a range of approximately 200° F. to 250° F.

4. The method of claim 1, wherein the dispensing step further comprises determining the predetermined amount of glue pellets to be dispensed based on the glue level in the reservoir.

5. The method of claim 1 further comprising retrying the dispensing step after a predetermined time, upon a determination that the glue temperature is below or equal to the temperature threshold value.

6. The method of claim 1 further comprising retrying the dispensing step after a predetermined time, upon a determination that the glue level is above or equal to the level threshold value.

7. A system for automatically controlling hot glue level in a book-binding apparatus, the system comprising:
a reservoir carrying the glue;
a level sensor configured to monitor glue level in the reservoir;
a temperature sensor configured to measure glue temperature in the reservoir; and
an automatic glue dispenser configured to dispense glue into the reservoir, upon a determination that:
the glue level is below a level threshold value; and
the glue temperature is above a temperature threshold value.

8. The system of claim 7, wherein the level threshold value lies within a range of approximately 75% to 100%.

9. The system of claim 7, wherein the temperature threshold value lies within a range of approximately 200° F. to 250° F.

10. The system of claim 7, wherein the automatic glue dispenser is further configured to determine the predetermined amount of glue pellets to be dispensed based on the glue level in the reservoir.

11. A method for automatically controlling hot glue level in a book-binding apparatus, the method comprising:
determining whether a book-binding operation is in progress;
upon a determination that a book-binding operation is not in progress, performing the steps of:
monitoring glue level in a reservoir;
measuring glue temperature in the reservoir; and
dispensing a predetermined amount of meltable glue pellets into the reservoir, upon a determination that:
the glue level is below a level threshold value; and
the glue temperature is above a temperature threshold value.

12. The method of claim 11 further comprising retrying the determining step after a predetermined time, upon a determination that a book-binding operation is in progress.
